(19) United States
(12) Patent Application Publication
(10) Pub. No.: US 2008/0060250 A1
(43) Pub. Date: Mar. 13, 2008

(54) Spear stopper

(76) Inventor: William May, Riverview, FL (US)

Correspondence Address: DEFILLO & ASSOCIATES, INC., P.O. Box 14104, Clearwater, FL, 33766, US

(21) Appl. No.: 11/520,188

(22) Filed: Sep. 13, 2006

(51) Int. Cl. A01K 81/04

(52) U.S. Cl. 43/6

(57) ABSTRACT

The present invention concerns a spear stopper adapted to be used in conjunction with a spear. The stopper comprises: a main body adapted to be slid onto a spear shaft, at least one wing pivotally connected to the front end of the main body, a threaded sleeve connected to the back end of the main body, a breaking clip being threaded over the threaded sleeve, and a locking nut connected to the breaking clip.

### TECHNICAL FIELD

The invention relates to spear fishing, and, in particular, to a spear stopper that prevents the spear from passing completely through the fish.

### BACKGROUND OF THE INVENTION

In recent years, the sport of spear fishing with spear guns has grown rapidly due to the greater availability of, and improvements in, underwater diving devices.

The prior art is replete with different types of fishing spears. It is typical that the spear be attached to a line or cable; thus, when the fish has been speared, both the spear and the fish may be retrieved by gathering in the cable.

An aggravation of spear fishing is that when a spear gun is set up for large or distant targets, and then is used to shoot a close-in or smaller target, the spear sometimes passes right through the fish. Even if the fish is mortally wounded, the fish may have sufficient life to leave and seek shelter allowing the line to wrap around underwater debris. In other instances, the spear is lost when the spear passes through the fish and sharp scales of some large fishes cut the line.

It is know in the art to use “Arrow stoppers” in land hunting, in order to prevent the arrow from going through the animal. However, arrow stoppers designed to work in thin air do not have problems of drag or premature deployment caused by the resistance of the water. Arrow stoppers will not work in dense water. There is thus a need for a spear stopper capable of preventing the back end of a spear from exiting the fish after the front of the spear has passed through the fish.

The prior art solved the underwater problem by including folding wings on the shaft of the spear to prevent the fish from sliding off the spear after penetration. Unfortunately, the folding wings according to the prior art expand after the penetration through the fish causing extreme scratching of the flesh of the fish.

In addition, the foldable wings of the prior art are fixed to the shaft of the spear and cannot be replaced. Thus, when the wings malfunction or wear off, the spear must be replaced. Also, the prior art shows elaborated mechanism to reverse the wings to it non-operational position.

Furthermore, the prior art also teaches adding a stopper or brake to the spear in order to prevent the spear passing though the fish. The basic design of the spear stopper according to the prior art comprises a plug made of rubber that is attached to the shaft of the spear. Unfortunately, this type of stopper is bulky, adds weight to the spear, and diminishes the fisherman possibilities of aiming the target.

Therefore, a long standing need has existed to provide a spear stopper which not only includes folding wings but which will permit better penetration, eliminates the scratching of the fish, can be replaceable, do not add too much weight to the spear, and include a quick release from the spear shaft.

Some of these disadvantages appear to have been overcome by the spear stopper disclosed in U.S. Pat. No. 6,811,503 entitled “Reconfigurable Spear Gun” to the present inventor. The content of which is incorporated herewith by reference. The spear stopper according to this reference comprises 1) a slide cylinder adapted to be slid onto a spear shaft, the front end of the cylinder includes a slot and the back end includes at least one slot; 2) a pair of wings pivotally connected to the front end of the slide cylinder; 3) a plurality of rubber bands, each rubber band is placed on each one of the slots; 4) a pin for connecting the wings to the slide cylinder. The slot of the front end allows the wings to move in the, downward and upward position.

Unfortunately, applicant encounters small problems with his previous spear stopper such as the flat front of the main body cylinder creates too much drag reducing the energy of the spear once fired; the band was exposed to the water creating drag and reducing energy of the spear; and not enough breaking action when high powered guns were used because the spear stopper was sliding down the shaft when fired.

The present invention is an improvement of the spear stopper disclosed in Applicant's previous patent.

### SUMMARY OF THE INVENTION

Therefore, it is an object of this invention to provide a spear stopper which is simple and inexpensive to manufacture, which substantially prevents the spear from passing through the fish and which is easy to attach to and remove from the spear.

It is yet another object of the present invention to provide a spear stopper including automatically means to prevent premature or unintended withdrawal of the spear after it has pass through a fish.

It is yet another object of the present invention to provide a spear stopper that reduces the drag and loss of energy once the spear is fired.

It is yet another object of the present invention to provide a spear stopper that does not slide down the shaft of the spear when fired.

Other objects and advantages of this invention will become more fully apparent as the description proceeds, reference being made to the accompanying drawings and appended claims.

The new design of the spear stopper according to the present invention allows the diver to better control the fish by grasping the spear. Also, the underwater environment is protected because the stopper prevents pass-through, thereby protecting the reefs, rocks, and unintended fish.

The spear stopper of the present invention is adapted to be used in conjunction with a spear, the stopper comprises:

a main body adapted to be slid into a spear shaft, the main body including a front end, a back end;

at least one wing pivotally connected to the front end of the main body;

a threaded sleeve connected to the back end of the main body;

a breaking clip connected to the threaded sleeve, the breaking clip including a first breaking clip and a second breaking clip, wherein the first and second breaking clip surround the threaded sleeve;

a locking nut connected to the breaking clip.

Furthermore, the front end of the main body has a bullet shape and includes a slot and a rubber band placed on the slot. The slot allows the wings to move in the downward and upward position, wherein when the wings move from the upward position to the downward position the rubber band rolls from the slot across the main body.

The foregoing detailed description shows that the preferred embodiments of the present invention are well suited to fulfill the objects of the invention. It is recognized that those skilled in the art may make various modifications or additions to the preferred embodiments chosen herein to illustrate the present invention, without departing from the spirit of the present invention. Accordingly, it is to be understood that the subject matter sought to be afforded protection hereby should be deemed to extend to the subject matter defined in the appended claims, including all fair equivalents thereof.

### BRIEF DESCRIPTION OF THE DRAWINGS

For a fuller understanding of the nature and objects of the invention, reference should be made to the following detailed description taken in connection with the accompanying drawings in which:

FIG. 1 shows a front view of the spear stopper in the open position, according to the present invention.

FIG. 2a shows a front view of the spear stopper in the closed position, according to the present invention.

FIG. 2b shows a side view of the spear stopper in the closed position, according to FIG. 2a.

FIG. 3 shows a closed front view of the spear stopper.

FIG. 4 shows an exploded view of the spear stopper according to the present invention.

FIG. 5 shows a top view of the spear stopper of FIG. 4.

FIG. 6 shows a side view of the clip of the spear stopper according to the present invention.

FIG. 7 shows a top view of the spear stopper of FIG. 3.

FIG. 8 shows a top view of the clip assembly according to the present invention.

FIG. 9 shows a detail view of the bottom part of the spear stopper according to the present invention.

FIG. 10 shows different views of the nut according to the present invention.

Similar reference characters refer to similar parts throughout the several views of the drawings.

### DETAILED DESCRIPTION OF THE INVENTION

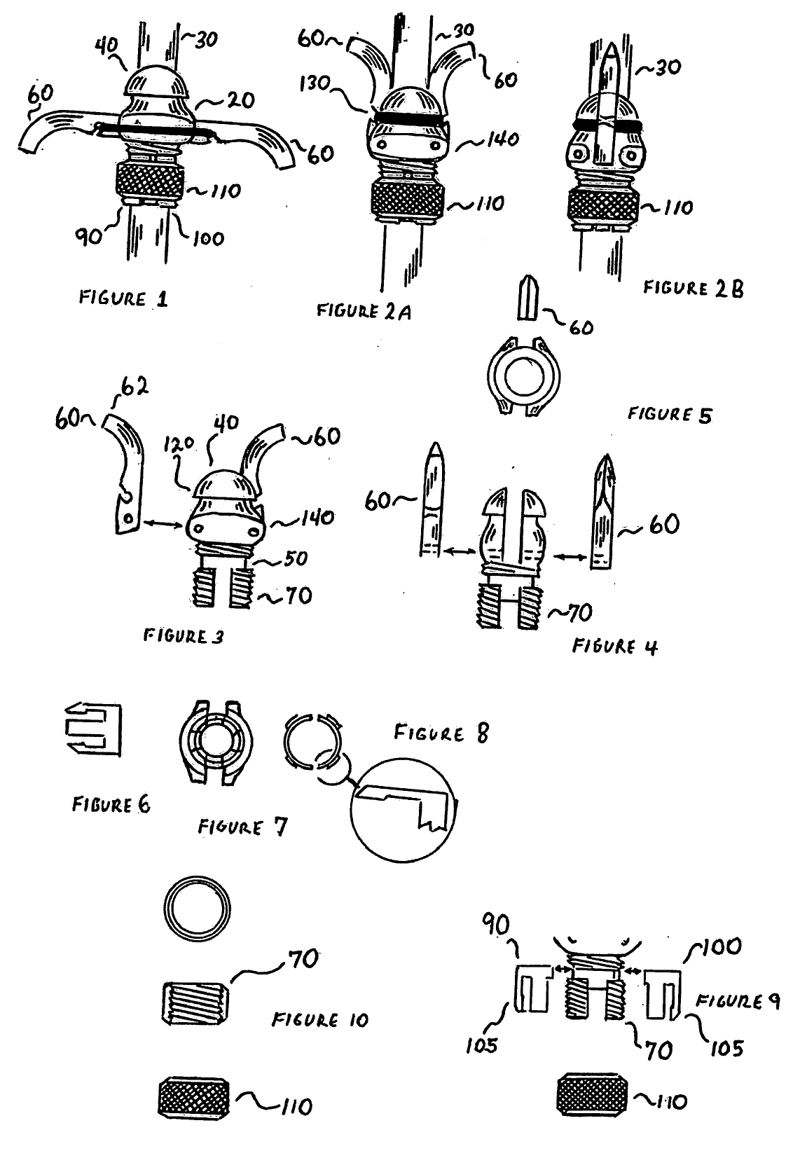

FIG. 1 shows a front view of the spear stopper in the open position, according to the present invention.

The spear stopper 10 adapted to be used in conjunction with a spear, the stopper comprising:

a main body 20 adapted to be slid into a spear shaft 30, the main body including a front end 40, a back end 50;

at least one wing 60 pivotally connected to the front end 40 of the main body 20;

a threaded sleeve 70 connected to the back end 50 of the main body 20;

a breaking clip 80 connected to the threaded sleeve, the breaking clip including a first breaking clip 90 and a second breaking clip 100, wherein the first and second breaking clip surround the threaded sleeve 70;

a locking nut 110 connected to the breaking clip 80.

The spear stopper according to the present invention prevents the back end of a spear from exiting the fish after the front of the spear has passed through the fish.

The stopper can be made of any number of rigid and durable materials, but preferable is made of a stainless steel. Depending on the size of the shaft of the spear the spear stopper can measure between 1.0 to 4.0 inches long, 0.5 to 1.50 inches wide.

The main body 20 is generally in the shape of an annular cylinder with an outer wall surface and an inner wall surface. The inner wall surface defines an opening slightly larger than the diameter of the shaft of the spear to allow the main body to slide on the spear shaft. The main body 20 measures between 0.75 to 2.0 inches long, 0.5 to 1.5 inches wide.

The main body 20 includes a front end and a back end. The front end comprises a slot 120 for receiving a rubber gasket 130 (rubber band). The slot is between 1.0 to 6.0 mm depth, preferably 2.1 mm depth. The slot allows the wings to move in the downward and upward position like a roller cam action. The rubber band is a cylindrical rubber gaskets having 2.1 mm thickness and 6 mm external diameter.

In Applicant's prior spear stopper, the rubber gasket was located at the front of the main body to hold the wings in the open position once fired. This prior design exposed the band to the water creating dragging and reducing energy from the spear. In order to prevent the above disadvantages, in the design of the stopper according to the present invention, the wings snap back into the closed position once the energy of the impact has subsided. Making the spear stopper more user friendly.

In addition, the rubber gasket that holds the wings in the close position now sits in a groove cut (slot) into the new bulleted front end eliminating exposure and greatly reducing drag of the spear once fired. The operation of the rubber gasket has been changed; it no longer snaps over and locks. It now simply slides up the smooth tapered main body of the spear stopper and then slides back into place.

The wings measure between 0.75 to 1.50 inches long, 0.15 to 0.35 inches wide. The overall open position from tip to tip is between 1.75 to 3.0 inches, preferably 2.5 inches. The overall closed position from tip to tip is between 0.90 to 1.40 inches, preferably 1.10 inches.

The wings 60 are pivotally attached to the main body 20 by any suitable fastening means, preferably a pin 140. The pin is fit into a hole through the main body and the wing, thus the wings are allowed to pivot in a downward and upward position.

Referring now in detail to FIG. 1, it can be seen that the wings 60 are fully expanded and that their bases reside against the main body. Thus, the wings extend at a 90° angle with respect to the longitudinal axis of the shaft 30. Referring now in detail to FIG. 3, it can be seen that the wings terminate in tips 62 which are inwardly flared.

Although Figures depict in the present application include two wings, it should be understood that other numbers of wings such as, one, three, five, and six can also be used.

It is the function of the rubber band to hold the wings against the spear shaft during the flight through the water. As the shaft of the spear enters the fish, the wings open up and the rubber stretches, and rolls across the main body of the stopper. As the band is pulled back by the wings it slides along the smooth tapered body into the open position. Once all the energy of the spear has been transfer to the fish, the band and wings will automatically go back to the closed position making the spear stopper ready to use again. Thus, once all energy is transferred and all the stopping action has ended the spear stopper will close automatically.

In order to reduce the drag in the water presented by the inventor's prior design, the front end of the spear stopper has been changed from flat to a bulleted shaped and the front end of the wings have been changed from flat to curved.

The design of Applicant's prior spear stopper does not provide enough breaking action when high powered guns are using this spear stopper because the spear stopper slides down the shaft when fired. In the present invention, the breaking bands on the rear of the prior spear stopper have been replaced by a thread down locking system that holds the stopper in place on the shaft preventing it from moving. This new design makes it easier for the operator since it no longer has to be put back in position after each firing.

The back end of the spear stopper has now a new thread down breaking/locking action. The breaking clip 80 includes first breaking clip 90 and second breaking clip 100. Both clips are made of a metallic material and include a locking tab 105. The breaking clips fit over the slotted threaded rear end of the spear stopper. The clips are placed surrounding the treaded sleeve on the back end of the stopper. Then a locking nut 110 is treaded all the way down the sleeve against the body of the spear stopper. This action allows the breaking clips to be compressed as the locking nut is passing over them and against the body. By threading the locking nut off the spear stopper, will compress the locking tabs against the body of the spear. The more you thread it back the tighter it gets until you can not thread it any more locking the spear stopper in place.

In this design, the main body is slid onto the spear shaft, then the threaded sleeve is placed at the back end of the main body. The breaking clips are placed surrounding the threaded sleeve and the nut is threaded back compressing breaking clips A & B against the spear shaft locking it in place. Thus, the spear stopper does not move down the spear shaft.

The spear stopper of the present invention helps in the retrieving of a hit fish because the spear stopper prevents the deep penetration beyond the fish causing the spear to be heavily weighted to one side, making it very difficult for the fish to stabilize itself which reduces his ability to travel any distance.

It is obvious that the spear stopper of the present invention can be applied also to arrows or other fishing implements.

Although this invention has been disclosed and described in its preferred form with a certain degree, of particularity, it is understood that the present disclosure of the preferred form is only by way of example, and that numerous changes in the details of operation and in the combination and arrangement of parts may be resorted to without departing from the spirit and scope of the invention as hereinafter claimed.

What is claimed is:

1. A spear stopper adapted to be used in conjunction with a spear, the stopper comprising:
a main body adapted to be slid onto a spear shaft, the main body including a front end, a back end;
at least one wing pivotally connected to the front end of the main body;
a threaded sleeve connected to the back end of the main body;
a breaking clip connected to the threaded sleeve, the breaking clip including a first breaking clip and a second breaking clip, wherein the first and second breaking clip surround the threaded sleeve;
a locking nut thread down to the threaded sleeve for holding the breaking clips in place to activate a breaking action.

2. The spear stopper according to claim 1 wherein the front end of the main body has a bullet shape.

3. The spear stopper according to claim 1 wherein the front end of the stopper includes a slot and a rubber gasket placed on the slot.

4. The spear stopper according to claim 3 wherein the slot allows the at least one wing to move in the downward and upward position, wherein when the at least one wing move from the upward position to the downward position the rubber band roll from the slot across the main body.

5. The spear stopper according to claim 1 wherein spear stopper is made of stainless steel.

6. The spear stopper according to claim 1 wherein the at least one wing have a front end and a back end, wherein the front end of the wing has a curved or bulleted shape.

7. The spear stopper according to claim 1 wherein main body has a smooth tapered surface.

8. The spear stopper according to claim 3 wherein as the shaft of the spear enters an animal, the wings open up and the rubber gasket stretches and rolls across the main body of the spear stopper.

9. The spear stopper according to claim 8 wherein as the rubber gasket is pulled back by the wings it slides along the main body into an open position.

10. The spear stopper according to claim 9 wherein the rubber gasket and the at least one wing automatically go back to a closed position after the spear enters the animal.
